(19) United States
(12) Patent Application Publication
(10) Pub. No.: US 2025/0272334 A1
(43) Pub. Date: Aug. 28, 2025

(54) IMAGE RETRIEVAL DEVICE, IMAGE RETRIEVAL METHOD, AND STORAGE MEDIUM

(71) Applicant: NEC Corporation, Tokyo (JP)

(72) Inventors: Naoya SOGI, Tokyo (JP); Makoto TERAO, Tokyo (JP); Takashi SHIBATA, Tokyo (JP)

(73) Assignee: NEC Corporation, Tokyo (JP)

(21) Appl. No.: 19/051,317

(22) Filed: Feb. 12, 2025

(30) Foreign Application Priority Data
Feb. 27, 2024 (JP) 2024-027288

(51) Int. Cl. G06F 16/535; G06V 10/44; G06V 10/74; G06V 10/75

(52) U.S. Cl. CPC G06F 16/535; G06V 10/44; G06V 10/759; G06V 10/761

(57) ABSTRACT

The image retrieval device 1X includes a first acquisition means 30X, a second acquisition means 33X, an integration means 342X, and a retrieval means 36X. The first acquisition means 30X acquires input information regarding a retrieval. The second acquisition means 33X acquires object region information regarding a region of an object included in images in an image database where the retrieval is performed. The integration means 342X calculates, as features of the images, image features obtained by integrating local features extracted from the images and the object region information. The retrieval means 36X retrieves an image related to the input information from the image database, based on a degree of similarity between the image features and features of the input information.

### INCORPORATION BY REFERENCE

This application is based upon and claims the benefit of priority from Japanese Patent Application No. 2024-027288, filed on Feb. 27, 2024, the disclosure of which is incorporated herein in its entirety by reference.

### TECHNICAL FIELD

The present disclosure relates to a technical field of an image retrieval device, an image retrieval method, and a storage medium for retrieving an image.

### BACKGROUND

A system for performing image retrieval based on information input by the user is known. For example, Patent Literature 1 discloses such an image retrieval system that a server device acquires images captured by a plurality of cameras to register in an image database and that the server device retrieves or extracts an image according to the text once a user inputs a text such as a keyword using a terminal device.

### CITATION LIST

### Patent Literature

Patent Literature 1: Japanese Patent No. 7366204

### SUMMARY

According to such an image retrieval system that converts images into features to retrieve an image based on the features, if a region of an object in an image is small, the information regarding the object is lost through conversion from the image into the features, causing the degradation in the retrieval accuracy regarding the object.

In view of the above-described issues, one object of the present disclosure is to provide an image retrieval device, an image retrieval method, and a storage medium capable of performing retrieval of an image with high accuracy.

In an example aspect of the present disclosure, there is provided an image retrieval device including:
a first acquisition means configured to acquire input information regarding a retrieval;
a second acquisition means configured to acquire object region information regarding a region of an object included in images in an image database where the retrieval is performed;
an integration means configured to calculate, as features of the images, image features obtained by integrating the object region information and local features which are extracted from the images; and
a retrieval means configured to retrieve an image related to the input information from the image database, based on a degree of similarity between the image features and features of the input information.

In an example aspect of the present disclosure, there is provided an image retrieval method executed by a computer, including:
acquiring input information regarding a retrieval;
acquiring object region information regarding a region of an object included in images in an image database where the retrieval is performed;
calculating, as features of the images, image features obtained by integrating the object region information and local features which are extracted from the images; and
retrieving an image related to the input information from the image database, based on a degree of similarity between the image features and features of the input information.

In an example aspect of the present disclosure, there is provided a storage medium storing a program executed by a computer, the program causing the computer to:

acquire input information regarding a retrieval;

acquire object region information regarding a region of an object included in images in an image database where the retrieval is performed;

calculate, as features of the images, image features obtained by integrating the object region information and local features which are extracted from the images; and

retrieve an image related to the input information from the image database, based on a degree of similarity between the image features and features of the input information.

An example advantage according to the present disclosure is to perform retrieval of an image with high accuracy.

### BRIEF DESCRIPTION OF THE DRAWINGS

FIG. 1 illustrates an outline configuration of an image retrieval system.

FIG. 2 illustrates the hardware configuration of an image retrieval device.

FIG. 3 illustrates an example of a functional block of the image retrieval device.

FIG. 4 illustrates a diagram schematically showing the flow of the process of generating image features.

FIG. 5 illustrates an outline of correction of the original query according to the second mode.

FIG. 6 illustrates an outline of a second selection example of the target original query to be corrected.

FIG. 7 illustrates an example of a flowchart showing an overview of the processing performed by the image retrieval device.

FIG. 8 illustrates an example of a functional block of an image feature extraction unit.

FIG. 9 illustrates an example of a functional block of the image retrieval device.

FIG. 10 is a block diagram of the image retrieval device.

FIG. 11 illustrates an example of a flowchart showing a processing procedure of the image retrieval device.

### EXAMPLE EMBODIMENTS

Hereinafter, example embodiments of an image retrieval device, an image retrieval method, and a storage medium will be described with reference to the drawings.

### First Example Embodiment

### (1) System Configuration

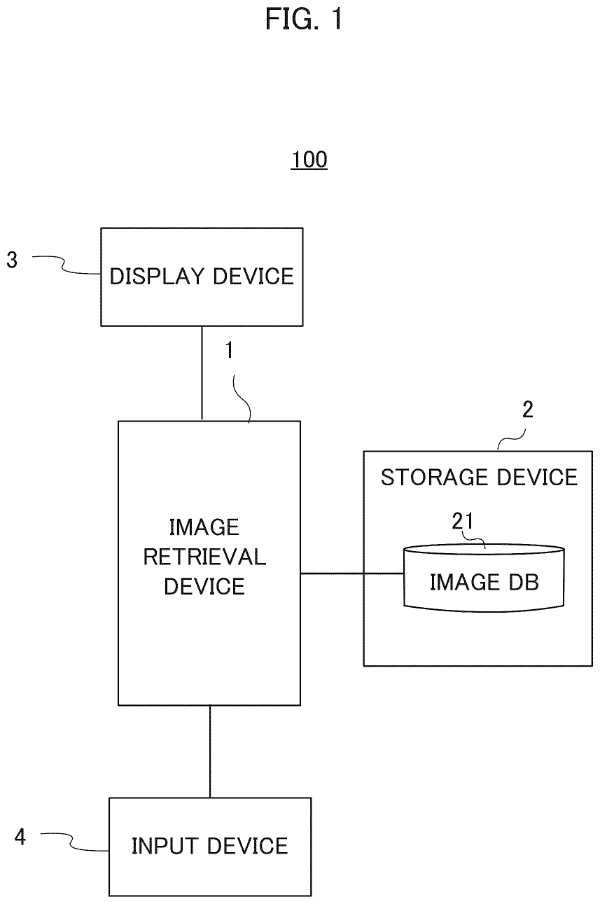

FIG. 1 shows a schematic configuration of an image retrieval system 100. On the basis of retrieval input information identified by an input signal supplied from an input device 4, the image retrieval system 100 retrieves an image related to the retrieval input information from an image database (DB) 21 stored in a storage device 2 and displays image retrieval results on a display device 3. The image retrieval system 100 mainly includes an image retrieval device 1, the storage device 2, the display device 3, and the input device 4.

The image retrieval device 1 performs retrieval of the image in the image DB 21 stored in the storage device 2 on the basis of the retrieval input information specified by the input signal supplied from the input device 4, and causes the display device 3 to display information indicating the retrieval result. In this case, the image retrieval device 1 retrieves the image based on the degree of similarity between the features extracted from the image of the image DB 21 and the features extracted from the retrieval input information, and displays the information representing the retrieval result on the display device 3. Hereafter, the features of each image used for calculation of the above-described degree of similarity for generating the retrieval result is referred to as “image features”, and the features of the retrieval input information is referred to as “retrieval input features”. The “features” are quantified features and conforms to a predetermined tensor format.

The storage device 2 is one or more memories which store various information necessary for the image retrieval device 1 to process data, and includes the image DB 21.

The image DB 21 is a database of target images of retrieval (i.e., candidate images for the retrieval) by the image retrieval device 1. Thereafter, the images registered in the image DB 21 are also referred to as “candidate images”. The candidate images include regions of objects.

The storage device 2 may be an external storage device, such as a hard disk, that is connected to or incorporated in the image retrieval device 1, or may be a storage medium, such as a portable flash memory. The storage device 2 may be one or more server devices that perform data communication with the image retrieval device 1. The storage device 2 may be configured by a plurality of devices.

The display device 3 displays information under the control of the image retrieval device 1. Examples of display device 3 include a display and a projector. Upon receiving a display signal supplied from the image retrieval device 1, the display device 3 displays information based on the received display signal.

The input device 4 is an interface for receiving a user input that is an external input based on an operation by a user who performs image retrieval using the image retrieval system 100, and examples of the input device 4 include a touch panel, a button, a keyboard, and a voice input device. The input device 4 supplies the image retrieval device 1 with the input signal generated based on the input from the user.

The configuration of the image retrieval system 100 shown in FIG. 1 is an example, and various changes may be made to the configuration. For example, the image retrieval device 1, the storage device 2, the display device 3, and the input device 4 may be configured integrally by any combination. The image retrieval system 100 may also include a sound output device such as a speaker. The image retrieval device 1 may be configured by a plurality of devices. In this case, the plurality of devices constituting the image retrieval device 1 transmits and receives information necessary for executing preassigned processing among the plurality of devices.

### (2) Hardware Configuration

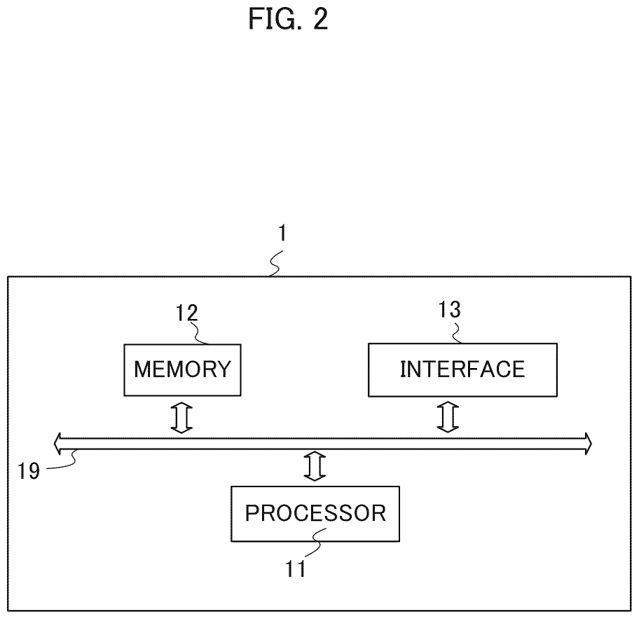

FIG. 2 illustrates a hardware configuration of the image retrieval device 1. The image retrieval device 1 includes a processor 11, a memory 12, and an interface 13 as hardware. The processor 11, memory 12 and interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by various volatile and non-volatile memories such as a RAM (Random Access Memory) and a ROM (Read Only Memory). Further, programs for executing various processing by the image retrieval device 1 are stored in the memory 12. The memory 12 is used as a working memory to temporarily store information and the like acquired from the storage device 2. The memory 12 may function as a storage device 2. The storage device 2 may function as the memory 12 of the image retrieval device 1. The program executed by the image retrieval device 1 may be stored in a storage medium other than the memory 12.

The interface 13 is one or more interfaces for electrically connecting the image retrieval device 1 to other devices. Examples of the interfaces include a wireless interface, such as a network adapter, for transmitting and receiving data to and from other devices wirelessly, and a hardware interface, such as a cable, for connecting to other devices.

The hardware configuration of the image retrieval device 1 is not limited to the configuration shown in FIG. 2. For example, the image retrieval device 1 may include at least one of a display device 3 and/or an input device 4. In another example, the image retrieval device 1 may be connected to or incorporate a sound output device such as a speaker.

### (3) Overview of Image Retrieval Processing

A description will be given of an overview of the image retrieval processing performed by the image retrieval device 1. In summary, the image retrieval device 1 generates object region information regarding a region of an object detected from each candidate image and calculates image features into which local features extracted from the each candidate image and the object region information are integrated. Thus, the image retrieval device 1 generates the image features considering the region of the detected object, and improves the retrieval accuracy even for the retrieval of the object whose region is small in the candidate image. Thereafter, the region of the object in the image is referred to simply as the “object region”.

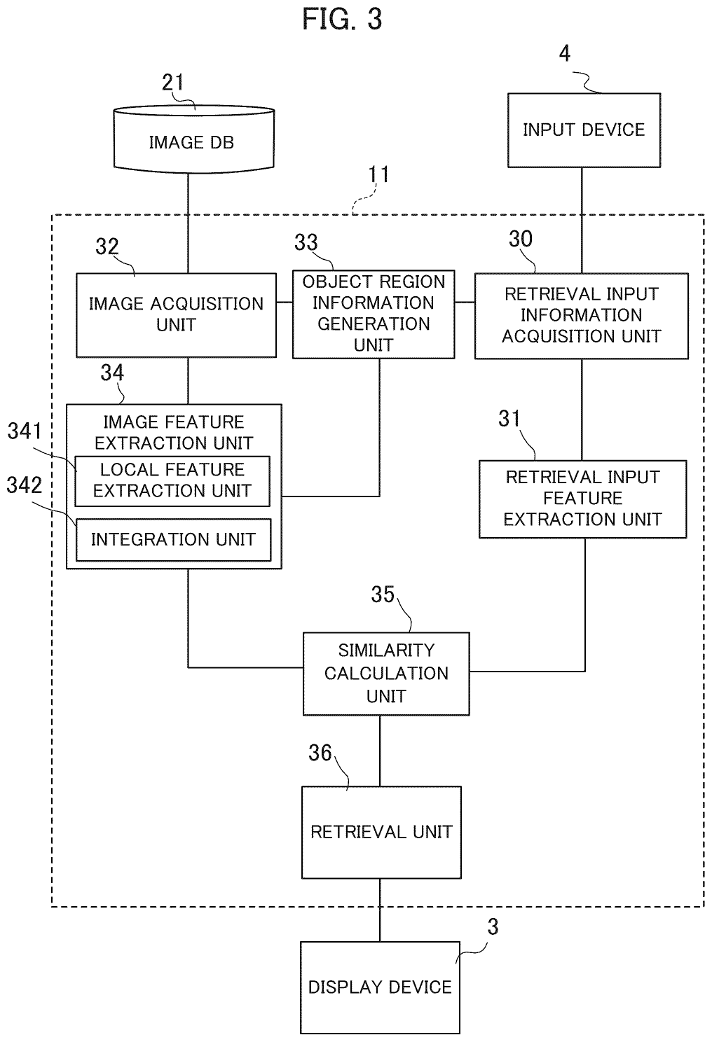

FIG. 3 is an example of functional blocks of the image retrieval device 1. As shown in FIG. 3, the processor 11 of the image retrieval device 1 functionally includes a retrieval input information acquisition unit 30, a retrieval input feature extraction unit 31, an image acquisition unit 32, an object region information generation unit 33, an image feature extraction unit 34, a similarity calculation unit 35, and a retrieval unit 36. In FIG. 3, blocks to exchange data with each other are connected by a solid line, but the combination of blocks to exchange data with each other is not limited thereto. The same applies to the drawings of other functional blocks described below.

The retrieval input information acquisition unit 30 acquires the retrieval input information on the basis of the input signal supplied from the input device 4 through the interface 13. The retrieval input information is any information specifying the image to be retrieved. For example, it includes text information specifying the image to be retrieved. The retrieval input information may include, in addition to or in place of the text information, information (also referred to as “positioning information”) indicative of the position (e.g., the right half of the image, the center of the image, etc.,) of the object on the image. In this case, the retrieval input information acquisition unit 30 may display a GUI (Graphical User Interface) for specifying the position on the image to accept the input specifying any position (including a region) on the image. The retrieval input information acquisition unit 30 supplies the acquired retrieval input information to the retrieval input feature extraction unit 31 and the object region information generation unit 33.

The retrieval input feature extraction unit 31 performs the feature extraction of the retrieval input information supplied from the retrieval input information acquisition unit 30 and generates the retrieval input features, which is the features of the retrieval input information. In this case, for example, the retrieval input feature extraction unit 31 acquires, as retrieval input features, features output by the feature extraction model upon inputting the retrieval input information to the feature extraction model. The above-described feature extraction model may be any feature extraction model for text information in a VLM (Vision-Language Model), such as a BLIP-2. The retrieval input feature extraction unit 31 may calculate the retrieval input features using only the text information included in the retrieval input information. The retrieval input feature extraction unit 31 supplies the generated retrieval input features to the similarity calculation unit 35.

The image acquisition unit 32 acquires the candidate images registered in the image DB 21 and supplies the acquired candidate images to the object region information generation unit 33 and the image feature extraction unit 34, respectively. The image features of each candidate image registered in the image DB 21 are calculated by the image feature extraction unit 34.

On the basis of the retrieval input information supplied from the retrieval input information acquisition unit 30 and the candidate images supplied from the image acquisition unit 32, the object region information generation unit 33 generates object region information that is information regarding regions of objects in the candidate images. The object region information may include information indicative of the detected object region (including parameters representing the position, the size, and the like), and may further include information indicative of the type (i.e., class through classification) of the detected object and the like. The object region information generation unit 33 supplies the generated object region information to the image feature extraction unit 34.

The image feature extraction unit 34 generates the image features based on the candidate images supplied from the image acquisition unit 32 and the object region information supplied from the object region information generation unit 33. The image feature extraction unit 34 functionally includes a local feature extraction unit 341 and an integration unit 342.

The local feature extraction unit 341 extracts the local features of the candidate images supplied from the image acquisition unit 32. The local features are features calculated from a partial region of an image, and may be a vector of pixel values of a small region (for example, a lattice region) obtained by regularly delimiting the image, or may be a feature map output by a convolution layer of a convolutional neural network. The local features calculated by the local feature extraction unit 341 is not limited to the above-described example, and may be any local features such as HOG (Histograms of Oriented Gradients), SIFT (Scaled Invariance Feature Transform), and Haar Wavelet. Hereafter, the region on the image used for calculation of local features is also referred to as “local region”.

The integration unit 342 generates image features based on the local features of candidate images and the object region information regarding the candidate images. In this case, in order to generate the image features by summing up the local features using the attention mechanism, the integration unit 342 determines, based on the object region information, at least one of the keys and/or the queries used in the attention mechanism. The integration unit 342 supplies the image features generated for each candidate image to the similarity calculation unit 35.

The similarity degree calculation unit 35 calculates the degree of similarity between the retrieval input features supplied from the retrieval input feature extraction unit 31 and the image features, for each candidate image, supplied from the image feature extraction unit 34. Here, an arbitrary index indicative of the degree of similarity calculated through comparison between features may be used as the degree of similarity. For example, the degree of similarity may be a cosine similarity, or may be a value output by the soft-max function upon inputting a multiplied cosine similarity into the soft-max function. The similarity degree calculation unit 35 supplies the above-described degree of similarity computed for each candidate image to the retrieval unit 36.

The retrieval unit 36 generates retrieval results of the candidate images related to the retrieval input information, based on the degree of similarity calculated by the similarity calculation unit 35 for each candidate image. Then, the retrieval unit 36 displays the retrieval results on the display device 3 by transmitting a display signal representing the generated retrieval results to the display device 3 via the interface 13. In this case, the retrieval results may be, for example, a list of a predetermined number of candidate images having top degrees of similarity according to each degree of similarity or the like, or a list of the top-degrees-of-similarity candidate images arranged according to a criterion other than the degree of similarity. In some embodiments, the retrieval unit 36 may generate captions (i.e., explanatory text) of each candidate image (also referred to as “display image”) to be displayed as the retrieval results and may display the generated caption on the display device 3 together with the each display image. For example, when VLM such as BLIP-2 is used, the retrieval unit 36 generates captions of the display images output by a LLM (Large Language Models) upon inputting the image features of the display images generated by the integration unit 342 to the LLM.

Here, for example, each component of the retrieval input information acquisition unit 30, the retrieval input feature extraction unit 31, the image acquisition unit 32, the object region information generation unit 33, the image feature extraction unit 34, the similarity calculation unit 35, and the retrieval unit 36 can be realized, for example, by the processor 11 executing a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

### (4) Generation of Object Region Information

A description will be given of the generation of the object region information by the object region information generation unit 33. The object region information generation unit 33 extracts the object region of each of candidate images which are selected based on the retrieval input information. By selecting the object region based on the retrieval input information, the object region information generation unit 33 can generate the object region information noticed in the portion according to the retrieval input information. Then, by calculating the image features considering such object region information, image retrieval according to the user's intent becomes possible.

In the first example of selecting the object region based on the retrieval input information, when the retrieval input information includes the text information, the object region information generation unit 33 extracts noun phrase(s) from the text information and extracts the object region of the object related to the extracted noun phrases from each candidate image. In this case, the object region information generation unit 33 may extract the noun phrases by arbitrary morphological analysis, or may extract the noun phrases from the text information using an arbitrary machine learning model (e.g., a language model) where machine learning is performed so as to extract the noun phrases from the input text. The learned parameters of the machine learning model are stored in the storage device 2 or the memory 12.

In the second example of selecting the object region based on the retrieval input information, when the retrieval input information includes positioning information which indicates the position of the target object of detection on the image, the object region generation unit 33 extracts the object region present in the position indicated by the positioning information from each candidate image. In the case where the retrieval input information includes both the text information and the positioning information, the object region information generation unit 33 extracts the object region, which is situated at the position indicated by the positioning information and which is to be selected based on the text information, from each candidate image.

Next, a description will be given of the specific method of extracting an object region from a candidate image. For example, the object region information generation unit 33 extracts an object region corresponding to a predetermined class from the candidate image using an arbitrary object detector (object detection model). Examples of such an object detector include object detectors such as Grounding DINO used in OVD (Open-Vocabulary Object Detection), which is the task of detecting an unknown object class specified in a text. Other examples of the object detector include YOLO (You Only Look Once). Yet other examples of the object detector include any model that utilizes segmentation results such as semantic segmentation, instance segmentation, panoptic segmentation, and the like. In some embodiments, the object region information generation unit 33 may determine, based on the results output by a plurality of object detectors, the object region to be finally output. In this case, the object region information generation unit 33 may integrate the results of the plurality of object detectors by generating the sum set thereof, or may integrate them by any integration method such as Non-Maximum Suppression.

Then, the object region information generation unit 33 generates object region information, regarding each candidate image, which includes parameters indicating the position and size of the object region, for example. Hereafter, as an example, the parameters indicating the position and the size of the object region are described as being four parameters “(x, y, w, h)”, wherein “(x, y)” indicates the image coordinate value of the representative point of the object region and “w” and “h” indicate the horizontal length and the vertical length of the object region, respectively. The parameters indicating the position and the size of the object region is not limited to the parameters on the assumption that the object region is a rectangle, but may be an arbitrary combination of parameters for specifying the object region. Further, the object region information generation unit 33 is not limited to including parameters of both the position and the size of the object region in the object region information, and may include parameters indicating at least the position of the object region in the object region information.

The object region information generation unit 33 may generate the object region information of each candidate image without using the retrieval input information. In this case, the object region information generation unit 33 generates object region information, which indicates an object region that is a characteristic region other than the background region, from each candidate image using an object detector established through machine-learning in advance so as to detect an object region of a specific class such as a car, a building, and a person. Even when the image features based on the object region information in which such retrieval input information is not considered are calculated, highly accurate image retrieval becomes possible.

### (5) Generation of Image Features Based on Object Region Information

Next, the generation of the image features based on the object region information by the integration unit 342 of the image feature extraction unit 34 will be described. The integration unit 342 determines, based on the object region information, at least one of the keys and/or the queries used in the attention mechanism when the local features are summed up to generate the image features using the attention mechanism. In the attention mechanism, integration with weighted sum is performed to determine, based on the degree of similarity of the queries and keys, the local regions of interest in the candidate images. Here, the attention mechanisms may be the self-attention or the cross-attention. The example embodiment can be applied to any system using the attention mechanism other than the above.

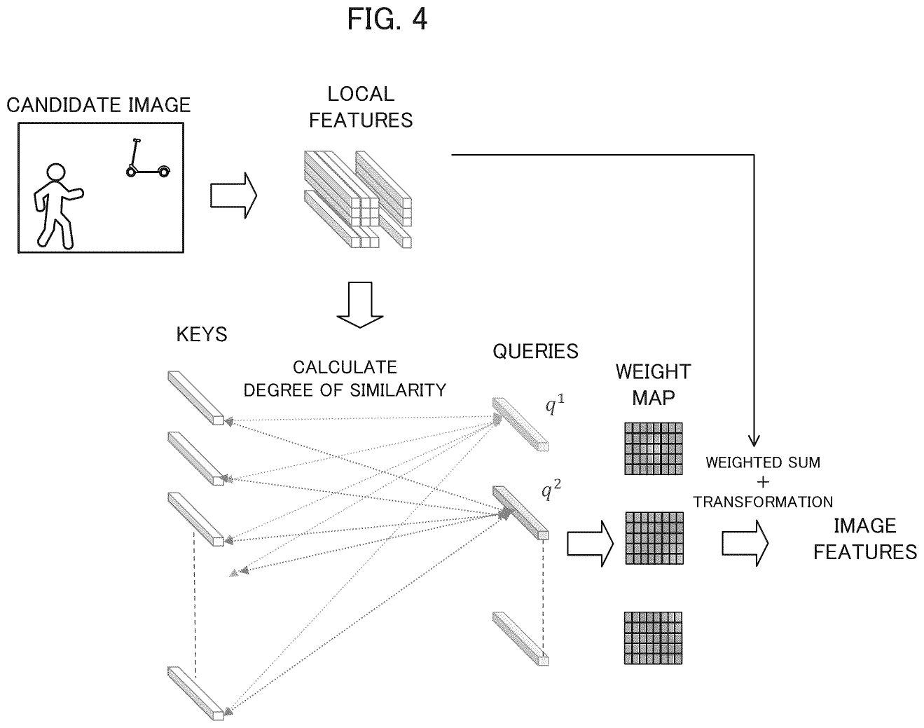

FIG. 4 schematically illustrates a flow of a process of generating the image features. In the example shown in FIG. 4, first, the local features are respectively calculated from the local regions in the candidate images.

Thereafter, the integration unit 342 temporarily sets keys and queries respectively based on the local features, and finally determines at least one of the set keys and/or queries based on the object region information. This determination method will be described later. Thus, the integration unit 342 sets the keys and the queries, respectively.

In one example of a method of determining keys and queries, the integration unit 342 temporarily determines the keys and queries regardless of the object region information, respectively, and then corrects, on the basis of the object region information, the temporarily determined keys and queries. Hereinafter, the keys computed regardless of the object region information are referred to as “original keys” and the queries computed regardless of the object region information are referred to as “original queries”. The same number of original keys are set as the number of the local features, and are generated from the local features using a neural network such as a multilayer perceptron or a combination of a neural network and a PE (Positional Embeddings). Original queries are determined differently depending on whether the self-attention or the cross-attention is used. For the self-attention, the original queries are computed from local features using a neural network and the like. On the other hand, for the cross-attention, the original queries are computed from learning parameters and local features using neural networks or the like. As a method of calculating the original keys and the original queries, any calculation method used in VLM (Vision-Language Model), such as BLIP-2, may be used.

Next, the integration unit 342 calculates, as weights, the degree of similarity of the keys and the queries, and generates, for each query, a weight map having the same number of weight elements as the number of the local features. The degree of similarity in this case may be a cosine similarity, or may be a value obtained by inputting a multiplied cosine similarity into the soft-max function. Each weight in the weight map increases with an increase in the degree of similarity of the corresponding key and query.

The integration unit 342 computes the weighted sum of the local features using the weight map and computes, as the image features, a value obtained by transforming the computed weighted sum by the neural network. In this case, since at least one of the keys and/or the queries are determined based on the object region information, the image features considering the object region information is calculated.

Next, a description will be given of modes (first mode and second mode) to determine the keys and the queries based on the object region information.

In the first mode, the integration unit 342 adds, to the original queries, information indicating the position (the size may be further considered) of the object region obtained by transforming the object region information while adding, to the original keys, information regarding the relative position (the size may be further considered) of the local region corresponding to the local feature. In the second mode, the integration unit 342 adjusts the magnitude of the components of the original queries projected onto the subspace of the original keys corresponding to the object region indicated by the object region information.

First, a method for determining the queries in the first mode will be described. Hereinafter, the i-th original query to be corrected is denoted by “qᵢ” and the final query obtained by correcting the original query is denoted by “qaᵢ”. The local features and learning parameters corresponding to the original query “qᵢ” is denoted by “mᵢ”, “φᵢ”, respectively.

The integration unit 342 calculates addition information (more specifically, a vector) p, which is added to (associated with) the original query qᵢ, using a neural network or the like from the parameters (x, y, w, h) regarding the position and size of the object region indicated by the object region information, and integrates the original query qᵢ with the calculated addition information p. The integration may be realized by the addition of vectors or may be a combination that extends the dimension of the vector.

For example, when the integration is realized by addition of vectors, the integration unit 342 calculates the query qaᵢ based on the following equation (1).

qaᵢ=qᵢ+p (1)

Here, given that “f” denotes the function to output the addition information p in response to the input of the parameters regarding the position and size of the object region, the equation (1) is rewritten as the equation (2) below.

qaᵢ=qᵢ+f₁(x,y,w,h) (2)

Here, the function f₁ is, for example, a neural network or a combination of a neural network and PE, and these learned parameters are previously stored in the storage device 2 or the memory 12 or the like. The arguments of the function f₁ may further include local features mᵢ or/and learning parameters Di.

For the self-attention, the original query qᵢ is expressed as follows using the local features mᵢ and the function “g”.

qᵢ=g(mᵢ)

The function g is, for example, a neural network or a combination of a neural network and PE, and these learned parameters are previously stored in the storage device 2 or the memory 12 or the like.

On the other hand, for the cross-attention, the original query qᵢ is expressed using the local features mᵢ and the learning parameters qᵢ and the function g as follows.

qᵢ=g(mᵢ,φᵢ) (i)

In some embodiments, the integration unit 342 according to the first mode may calculate the query qaᵢ without using the original query qᵢ, instead of correcting the original query qᵢ using the function value based on the parameters regarding the position and size of the object region as described in the equation (1).

Specifically, for the self-attention, the integration unit 342 determines the query qaᵢ as shown in the following equation (3) using the function f₂ and the parameters (x, y, w, h) regarding the position and size of the object region, and the local features mᵢ.

qaᵢ=f₂(x,y,w,h,mᵢ) (3)

On the other hand, for the cross-attention, the function f₃ and parameters (x, y, w, h) regarding the position and size of the object region, the local features mᵢ, and the learning parameters φᵢ are used to determine the query qaᵢ as shown in the equation (4).

qaᵢ=f₃(x,y,w,h,mᵢ,i) (4)

The function f₂ and function f₃ used in the equations (3) and (4) each is a neural network or a combination of a neural network and PE, and these learned parameters are previously stored in the storage device 2 or the memory 12 or the like. For example, an architecture such as DAB-DETR (Dynamic Anchor Boxes are Better Queries for DETR) can be applied to the function f₂ and function f₃.

Here, a supplementary description will be given of a method of determining a query based on the first mode when the object region information indicates a plurality of object regions.

First, a description will be given of the calculation of the addition information p in the case where the object region information indicates a plurality of object regions. In this case, the integration unit 342 computes pieces of addition information p for respective object regions, and computes the average (any statistical representative value other than average may be used instead, hereinafter the same) of all the computed pieces of addition information p. The integration unit 342 obtains the query qaᵢ by integrating the average of the computed pieces of addition information p with the original query qᵢ. In some embodiments, the integration unit 342 may perform feature extraction on the pieces of addition information p computed for respective object regions and then determine the query qaᵢ obtained by integrating the average of the extracted features of the pieces of addition information p with the original query qᵢ. In some embodiments, the integration unit 342 may classify the objects represented by the object regions and calculate the average of the addition information p or the average of the features of the addition information p for each class of the objects. In this case, the integration unit 342 obtains the class-specific average of the addition information p for each class of the objects or the class-specific average of the features of the addition information p, and then determines the overall average of the class-specific averages regarding all classes of the objects. Then, the integration unit 342 determines the query qaᵢ obtained by integrating the overall average regarding all classes of the objects with the original query qᵢ.

Next, a description will be given of the case where the object region information indicates a plurality of object regions and the query qaᵢ is calculated according to the equation (3) or equation (4). In this case, the integration unit 342 computes a tentative query for each object according to the equation (3) or equation (4) for each of the object regions. Then, the integration unit 342 determines that the final query qaᵢ is the average (any statistical representative value other than average may be used instead, hereinafter the same) of all the calculated tentative queries. The integration unit 342 may extract the features from the tentative queries calculated for respective object regions and obtain the final query qaᵢ using the average of the obtained features. The integration unit 342 may classify an object indicated by an object region and calculate the average of the tentative queries or the average of the features of the tentative queries for each class of the objects. In this case, the integration unit 342 firstly calculates the class-specific average of the tentative queries or the average of the features of the tentative queries for each class of objects, and then calculates the overall average of the class-specific averages for all classes of the objects to determine that the final query qaᵢ is the overall average for all classes of the objects.

Next, a description will be given of a method for determining a key based on the first mode. Hereafter, “kᵢ” denotes the i-th original key to be corrected and “kaᵢ” denotes the final key obtained by correcting the original key. Besides, “mᵢ” denotes the local features corresponding to the original key “kᵢ”.

In this case, the integration unit 342 adds parameters indicating the relative position (i.e., the position in the candidate image) of the local features mᵢ to the original key kᵢ. For example, given that (xᵢ, yᵢ) denotes the coordinate position in the candidate image of the local region used for calculating the local features mᵢ, “wᵢ” denotes the horizontal length of the local region, and “hᵢ” denotes vertical length, the integration unit 342 adds, to the original key kᵢ, the value outputted by the function f₄ whose arguments include the parameters indicating the relative position of the local features mᵢ, as shown in the following equation (5).

kaᵢ=kᵢ+f₄(xᵢ,yᵢ,wᵢ,hᵢ) (5)

Here, the function f₄ is, for example, a neural network or a combination of a neural network and PE, and these learned parameters are previously stored in the storage device 2 or the memory 12 or the like. The original key kᵢ is computed from the local features mᵢ using a neural network or the like.

Next, a description will be given of the second mode regarding the determination method of the queries based on object region information. In the second mode, the integration unit 342 adjusts the information, included in the original query, of the original key corresponding to the object region. Specifically, the integration unit 342 corrects the original query so as to enhance the information of the original key corresponding to the object region, which is included in the original query. As will be described later, in some embodiments, for a specific object region, the integration unit 342 may correct the original query so as to weaken the information, included in the original query, of the original key corresponding to the object region.

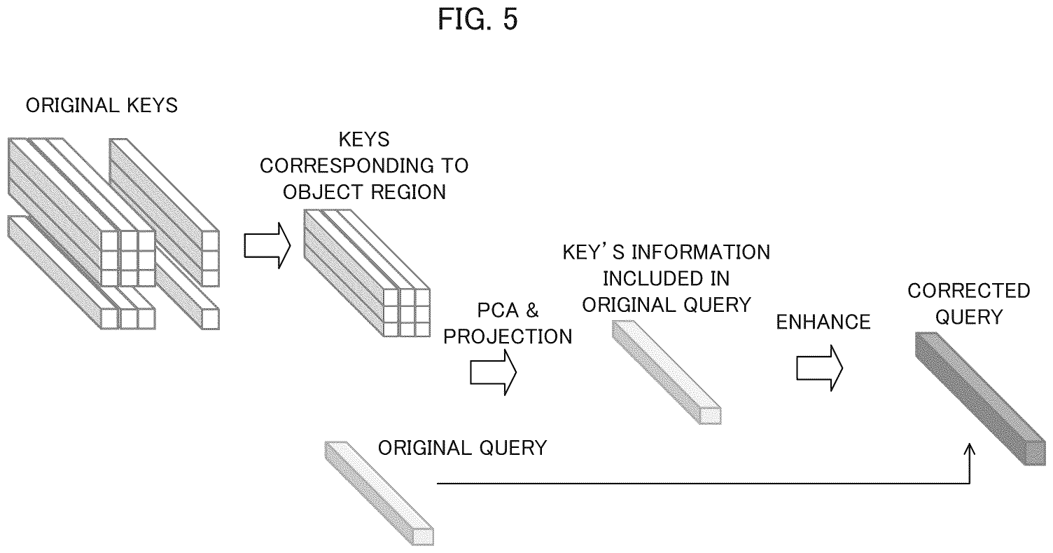

FIG. 5 is a diagram showing an outline of correction of the original query in the second mode. First, the integration unit 342 extracts original keys (also referred to as “object region corresponding keys”) corresponding to the object region from all the original keys generated from the candidate image. In this case, the integration unit 342 refers to the object region information corresponding to the candidate image and extracts, as the object region corresponding keys, the original keys corresponding to the local features calculated from the object region which is indicated by the object region information.

Next, the integration unit 342 applies the principal component analysis to the object region corresponding keys to thereby generate a subspace, and then extracts the information of the object region corresponding keys originally included in the original query by projecting the corresponding original query onto the generated subspace. In some embodiments, before the principal component analysis, the integration unit 342 may multiply each key corresponding to each object region by a weight according to the degree of importance thereof. Here, the “weight according to the degree of importance” may be, for example, a value based on the size (e.g., the area of the object region) of the object region in the candidate image to which the each key belongs, or may be a value based on the distance between the center position of the object region to which the each key belongs and the position on the candidate image corresponding to the each key.

Next, the integration unit 342 multiplies information, included in the original query, of the object region corresponding keys by a predetermined coefficient α (a is a value larger than 1), and adds, to the original query, the object region corresponding key information multiplied by the coefficient α in the original query. Thus, the integration unit 342 can correct the original query so as to enhance the object region corresponding key information included in the original query. The coefficient α may be a predetermined value stored in the storage device 2 or the memory 12 or the like in advance, or may be set according to a predetermined equation or a look-up table based on the size of the object region.

If the candidate image includes such an object region indicative of an object which is not appropriate to be included in the retrieval result, the integration unit 342 may correct the original query so as to weaken the object region corresponding key information included in the original query. In this case, first, the integration unit 342 refers to the object region information. Then, upon determining that the candidate image includes such an object region indicative of an object which is not appropriate to be included in the retrieval result, the integration unit 342 extracts the object region corresponding key corresponding to the object region. The “object which is not appropriate to be included in the retrieval” may be an object which belongs to a predetermined class, or may be an object designated by the retrieval input information as an object to be excluded. Then, the integration unit 342 multiplies the information, included in the original query, of the object region corresponding key by a predetermined coefficient β (β is a value smaller than 0), and adds the object region corresponding key information which is included in the original query and multiplied by the coefficient β to the original query.

Next, a description will be given of the selection of the original query to be corrected based on the first mode or the second mode.

In the first selection example, the integration unit 342 regards all the original queries generated from the candidate images as correction targets, and corrects each of the all original queries according to the first mode or the second mode.

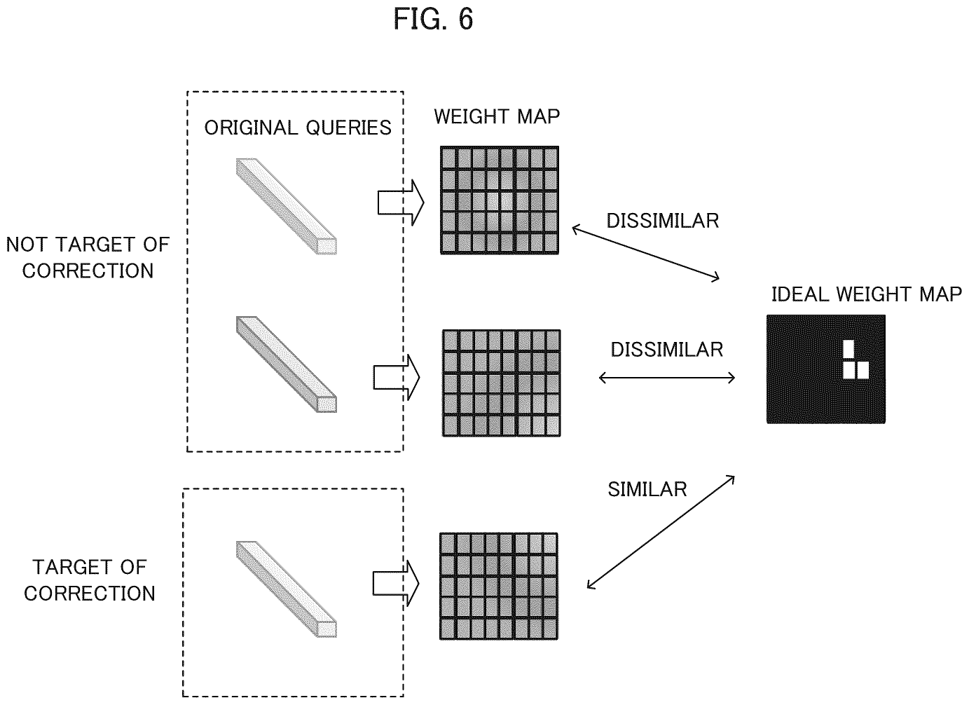

In the second selection example, the integration unit 342 determines, based on the weight map calculated using the original keys and the original queries, the original queries to be corrected. FIG. 6 is a diagram illustrating an outline of a second selection example of the original queries to be corrected. In FIG. 6, for convenience of description, three original queries are specified, and a weight map is generated from each original query. Here, the weight map is the weight map shown in FIG. 4, and is a map in which the degrees of similarity between the original keys and the original queries are used as weights.

The integration unit 342 calculates the degree of similarity between the weight map corresponding to each original query and the ideal weight map, and determines, based on the calculated degree of similarity, whether there is a similarity or dissimilarity between the weight map corresponding to each source query and the ideal weight map. The degree of similarity calculated by the integration unit 342 may be any index used as an index of the degree of similarity between two images. For example, the integration unit 342 computes the degree of cosine similarity between the weight map corresponding to each original query and the ideal weight map.

Here, the ideal weight map is, for example, a map generated from the object region information, and is a weight map in which the object region is set to be a high weight and the region (i.e., the background region) other than the object region is set to be a low weight. Here, as an example, the ideal weight map is a mask image indicating the object region specified based on the object region information. In the mask image, the largest pixel value (white in the figure) corresponds to the object region and the lowest pixel value (black in the figure) corresponds to the background region.

The integration unit 342 determines that a weight map is similar to the ideal weight map if the degree of similarity between the weight map and the ideal weight map is equal to or more than a predetermined threshold value or the ranking of the degree of similarity is top M (M is a positive integer). In contrast, the integration unit 342 determines that the other weight maps are dissimilar to the ideal weight map. Then, the integration unit 342 regards an original query corresponding to the weight map that is determined to be similar to the ideal weight map as a correction target and corrects, on the basis of the above-described first mode or the second mode, the original query. Further, the integration unit 342 regards original queries corresponding to the weight map that is determined not to be similar to the ideal weight map as a non-correction target and leaves the original queries as they are without performing correction according to the first mode or the second mode described above.

### (6) Processing Flow

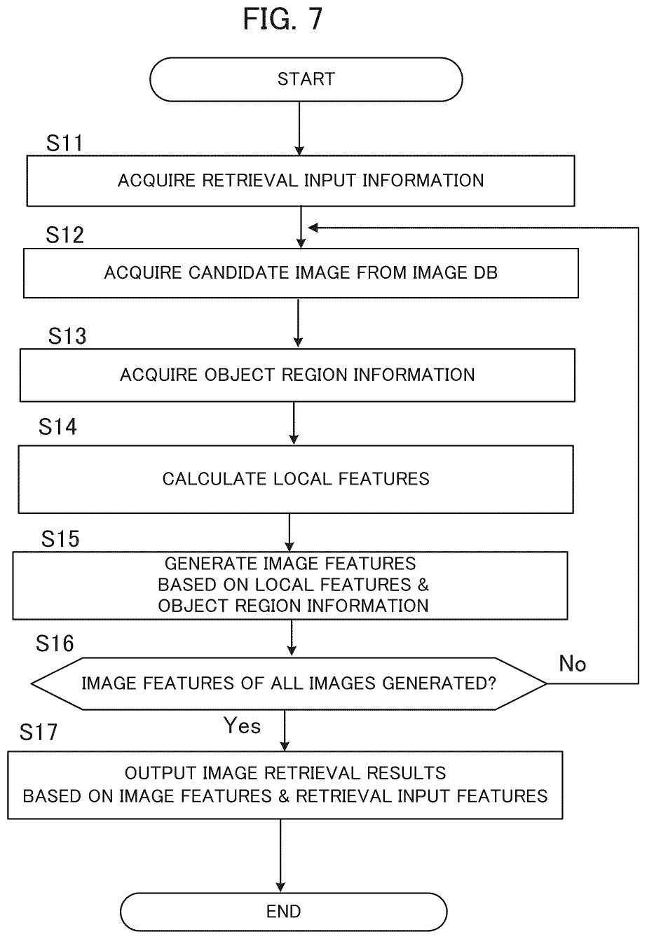

FIG. 7 is an example of a flowchart illustrating an overview of an image retrieval process performed by the image retrieval device 1.

First, the image retrieval device 1 acquires the retrieval input based on the input signal supplied from the input device 4 (step S11). In this case, the image retrieval device 1 may display the input screen image for receiving the user input (external input) related to the retrieval input information on the display device 3. At any timing after the process at step S11 and by the time of the beginning of the process at step S18, the image retrieval device 1 calculates the retrieval input features which are the features of the retrieval input information.

Next, the image retrieval device 1 acquires a candidate image from the image DB 21 (step S12). Then, the image retrieval device 1 acquires the object region information regarding the candidate image acquired at step S12 (step S13). In this instance, the image retrieval device 1 detects object region(s) from the candidate image acquired at step S12 using, for example, an object detector generated through machine-learning, and generates object region information based on the detection results of the object region. In this instance, the image retrieval device 1 may identify one or more target objects of detection based on the retrieval input information acquired at step S11 and generate object region information regarding the identified objects.

Next, the image retrieval device 1 computes the local features of the candidate image acquired at step S12 (step S14). Then, the image retrieval device 1 generates the image features based on the local features calculated at step S14 and the object region information acquired at step S13 (step S15). In this instance, the image retrieval device 1 determines, based on the object region information, at least one of the keys and/or the queries used in integrating the local features based on the attention mechanism.

Next, the image retrieval device 1 determines whether or not the image features are generated for all images registered in the image DB 21 (step S16). If the image features are not generated for all the images registered in the image DB 21 (step S16; No), the image retrieval device 1 proceeds back to the process at step S12 and acquires another candidate image in which the image features are not generated from the image DB 21.

On the other hand, if the image features are generated for all the images registered in the image DB 21 (step S16; Yes), the image retrieval device 1 outputs image retrieval results based on the degree of similarity between the image features of each candidate image and the retrieval input features (step S17). In this case, the image retrieval device 1 determines that the higher degree of similarity between the image features of a candidate image and the retrieval input features is, the higher priority to be output as the image retrieval results the candidate image has, and determines the candidate images to be output as the retrieval results and their priorities in the output. Then, the image retrieval device 1 transmits a display signal indicating the image retrieval results to the display device 3, and causes the display device 3 to display information related to the retrieval results.

### (7) Learning of Image Feature Extraction Unit

Next, a description will be given of learning (i.e., machine learning) of the image feature extraction unit 34 which is executed before the image retrieval process by the image retrieval device 1. It is hereafter assumed that the image retrieval device 1 performs learning of the image feature extraction unit 34. However, instead, a device other than the image retrieval device 1 may perform learning of the image feature extraction unit 34. The parameters obtained by learning when the image retrieval device 1 or the device other than the image retrieval device 1 performs learning are stored in the storage device 2 or the memory 12 before the image retrieval process so that the image retrieval device 1 can refer to the parameters in the image retrieval process.

In the learning of the image feature extraction unit 34, a training data set is stored in the storage device 2 or the memory 12, and the image retrieval device 1 updates the parameters of the image feature extraction unit 34 using the training data set.

Here, the training data set includes a plurality of records, and each record corresponds to a set (so-called “positive example set”) of a training image used for training and input information suitable for retrieving the training image. The input information in this case may be text information, and may be any information that can be designated as retrieval input information (e.g., positioning information indicative of the position in the image).

The image retrieval device 1 regards the training image as the candidate image to generate the object region information by the object region information generation unit 33 and compute the image features by the image feature extraction unit 34. Then, the image retrieval device 1 determines the parameters of the image feature extraction unit 34 such that the loss (error) based on the image features of the training image and the retrieval input features calculated by the retrieval input feature extraction unit 31 from the input information that is a counterpart of the training image is minimized. The algorithm for determining the parameters described above may be any training algorithm used in machine learning, such as a gradient descent method and an error back propagation method. In this case, any optimization technique, such as a stochastic gradient descent method (SGD: Stochastic Gradient Descent) and Adam, may be used. The loss function defining the above-described loss may be any loss function such that the lower the degree of similarity between the retrieval input features and the image features is, the higher the loss becomes, or any loss function for discriminating whether the training image and the input information are a positive pair or not.

The target parameters of learning in the image feature extraction unit 34 may be all the parameters of the image feature extraction unit 34 or may be a part of the parameters of the image feature extraction unit 34. In the first example in which a part of parameters of the image feature extraction unit 34 are used as the target parameters of the learning, the image retrieval device 1 determines the parameters of the function used in the first mode regarding correction of the original keys and the original queries as the target parameters of learning. In the second example in which a part of the parameters of the image feature extraction unit 34 are used as the target parameters of learning, the image retrieval device 1 adds learnable parameters to the image feature extraction unit 34 and learns the added parameters. For the addition of such parameters, for example, Visual Prompt Tuning may be used. It should be noted that the above-described first example and the second example may be implemented in combination.

### (8) Modifications

Next, modifications suitable for the above-described example embodiment will be described. The following modifications may be applied to the example embodiments described above in combination.

### (First Modification)

The image retrieval device 1 may repeat the process of the integration unit 342 multiple times in a recursive manner.

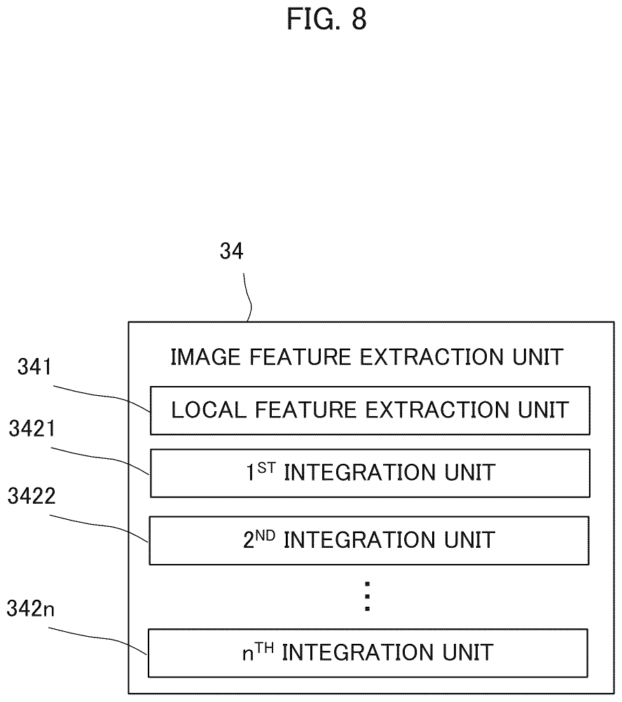

FIG. 8 is an example of a functional block of the image feature extraction unit 34. The image feature extraction unit 34 includes a local feature extraction unit 341 and n integration units 342 (first integration unit 3421 to n-th integration unit 342n, where n is an integer of 2 or more).

The first integration unit 3421 performs the same processing as the integration unit 342 described in FIG. 3 does, and generates the image features based on the local features and the object region information. Then, the second integration unit 3422 regards the image features output by the first integration unit 3421 as queries (original queries) and generates the image features based on the local features calculated by the local feature extraction unit 341 and the object region information. Each of the third integration unit 3423 to the n-th integration unit 342n also regards image features output by the immediately-preceding integration unit having one less serial number as queries (original queries) and generates the image features based on the local features computed by the local feature extraction unit 341 and object region information. Then, the similarity calculation unit 35 computes the degree of similarity between the image features output by the n-th integration unit 342n and the retrieval input features. The repetition of recursive processing of such an integrating part makes it possible to generate more accurate image features.

It is noted that at least one integration unit which uses the object region information may exist among the first integration unit 3421 to the n-th integration unit 342n. In this case, any integration unit without using the object region information does not perform the processing of correcting the original keys and the original queries by the object region information, and generates a weight map based on the degree of similarity between the original keys and the original queries to generate the image features from the weight map.

### (Second Modification)

The image retrieval device 1 may execute the image retrieval process using the object region information generated before the image retrieval process.

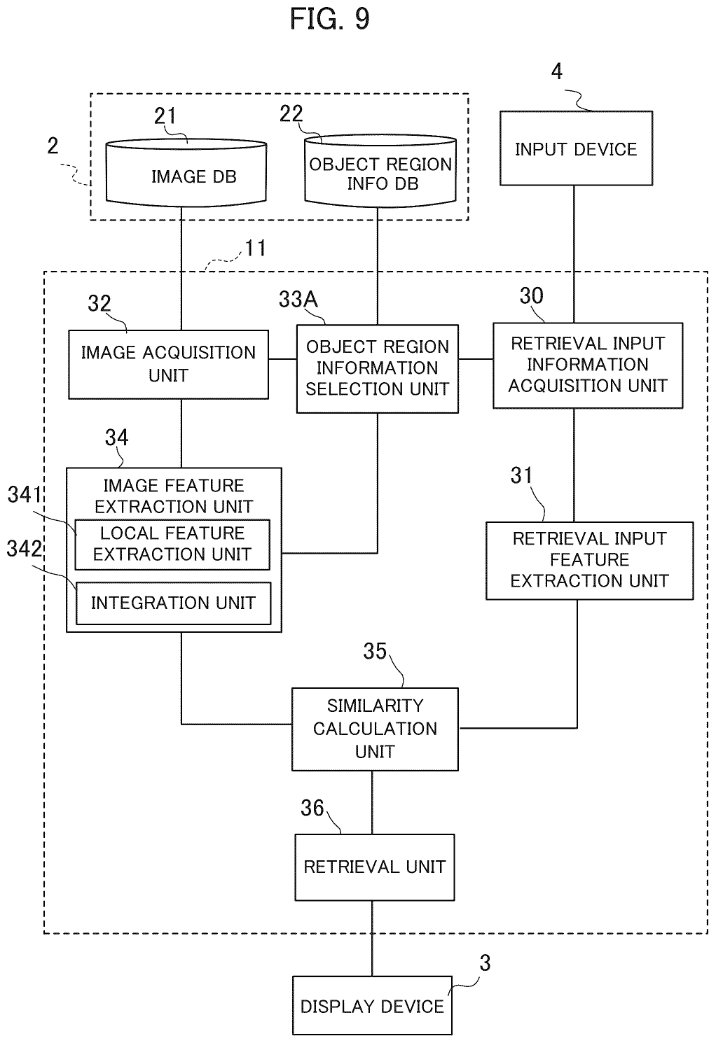

FIG. 9 is an example of functional blocks of the image retrieval device 1. The processor 11 of the image retrieval device 1 functionally includes a retrieval input information acquisition unit 30, a retrieval input feature extraction unit 31, an image acquisition unit 32, an object region information selection unit 33A, an image feature extraction unit 34, a similarity calculation unit 35, and a retrieval unit 36. The retrieval input information acquisition unit 30, the retrieval input feature extraction unit 31, the image acquisition unit 32, the image feature extraction unit 34, the similarity calculation unit 35, and the retrieval unit 36 shown in FIG. 9 perform the same processing as the retrieval input information acquisition unit 30, the retrieval input feature extraction unit 31, the image acquisition unit 32, the image feature extraction unit 34, the similarity calculation unit 35, and the retrieval unit 36 do, respectively, and thus their description will be omitted as appropriate. The storage device 2 stores the image DB 21 and the object region information DB 22.

The object region information DB 22 is a database of the object region information corresponding to each candidate image registered in the image DB 21. The object region information is information generated based on detection results of objects in the candidate images in the image DB 21 detected by the image retrieval device 1 or any other device before the image retrieval process. If a candidate image includes a plurality of objects, the object region information corresponding to each object is registered in the object region information DB 22 in association with the candidate image.

In addition, in the object region information DB 22, for each object included in the candidate images, metadata regarding the each object is added to the object region information. The metadata described above is, for example, text information indicative of one or more nouns or the like associated with the object in the object region. The metadata may include information (e.g., information indicative of the position on the image) other than the text information, instead of or in addition to the text information. In addition, the metadata further includes identification information (e.g., image ID) of the candidate image where the object indicated by the object region information is detected. In some embodiments, the identification information is associated with each candidate image.

The object region information selection unit 33A extracts related object region information from the object region information DB 22, on the basis of the candidate image supplied from the image acquisition unit 32 and retrieval input information supplied from the retrieval input information acquisition unit 30. In this case, the object region information selection unit 33A selects object region information from the object region information DB 22, wherein the selected object region information is associated with the identification information of the candidate image and has metadata related to (i.e., matching or similar to) the retrieval input information. The object region information selection unit 33A supplies the selected object region information to the image feature extraction unit 34.

In some embodiments, if the metadata and the retrieval input information include text information, the object region information selection unit 33A may determine the similarity/dissimilarity between the metadata and the retrieval input information, using a scale for evaluating consistency of texts such as a BLUE, CIDEr, SPICE as the degree of similarity. In some embodiments, the object region information selection unit 33A may make a similarity determination between the metadata and the retrieval input information, on the basis of the degree of similarity of the features generated through Word2Vec, Doc2Vec or currently-using VLM. The object region information selection unit 33A may select only the object region information associated with metadata having a degree of similarity with the retrieval input information equal to or greater than a predetermined threshold value. Instead, the object region information selection unit 33A may select only the object region information associated with metadata having top M (M is a positive integer) degrees of similarity with the retrieval input information.

The object region information selection unit 33A may not use the retrieval input information. In this case, the object region information selection unit 33 A selects, from the object region information DB 22, the object region information associated with the candidate image supplied from the image acquisition unit 32. The object region information selection unit 33A may select, based on the retrieval input information regardless of the candidate image supplied from the image acquisition unit 32, the object region information associated with the retrieval input information and supply the selected object region information to the image feature extraction unit 34. In this case, the image feature extraction unit 34 acquires, from the image acquisition unit 32, only the candidate image related to the object region information supplied from the object region information selection unit 33A as a candidate to be included in the retrieval results, and may calculate the image features of the selected candidate image.

According to this modification, the image retrieval device 1 can suitably reduce the processing load required for generating the object region information in the image retrieval process.

### (Third Modification)

The image retrieval device 1 may divide the retrieval results into a plurality of classes according to the size of the object region included in the positive example image of the retrieval input. Then, after computing the evaluation index values for respective classes, the image retrieval device 1 may compute the final evaluation index value obtained by integrating the evaluation index values through statistical processing such as averaging.

As the evaluation index described above, any recommendation evaluation index, such as Recall@K and Median Rank, may be used. As the “size of the object region” described above, for example, a ratio of the area of the object occupied in the image may be used. Further, in one example of a method of dividing the retrieval results, the image retrieval device 1 determines, based on the maximum value or the minimum value of the size of the object region of the positive example image, the divisions to which the retrieval results belong. For example, the image retrieval device 1 may divide the retrieval results per 10% according to the ratio of the area of the object occupying the image. In this case, ten classes are generated, including the class corresponding to the the above ratio from 0% to 10%, the class corresponding to the ratio from 10% to 20%, and the class corresponding to the ratio from 90% to 100%, and the evaluation index values corresponding to respective classes are calculated.

### Second Example Embodiment

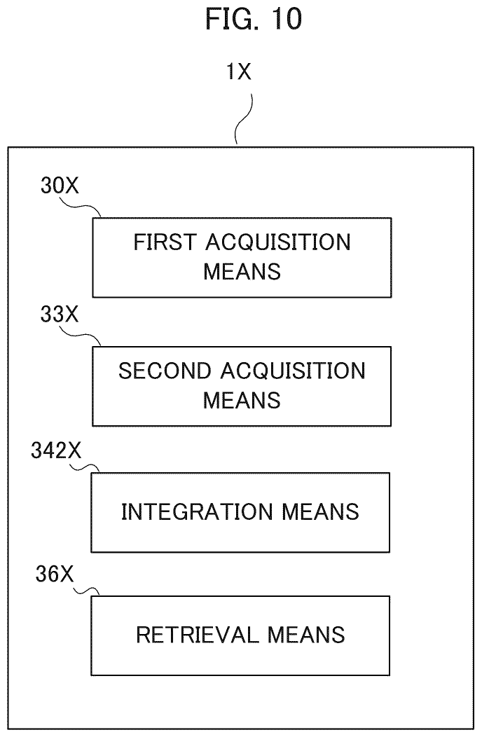

FIG. 10 is a block diagram of an image retrieval device 1X. The image retrieval device 1X includes a first acquisition means 30X, a second acquisition means 33X, an integration means 342X, and a retrieval means 36X. The image retrieval device 1X may be configured by a plurality of devices.

The first acquisition means 30X is configured to acquire input information regarding a retrieval. Examples of the first acquisition means 30X include the retrieval input information acquisition unit 30 in the first example embodiment (including the modification, hereinafter the same).

The second acquisition means 33X is configured to acquire object region information regarding a region of an object included in images in an image database where the retrieval is performed. Examples of the second acquisition means 33X include the object region information generation unit 33 and the object region information selection unit 33A in the first example embodiment.

The integration means 342X is configured to calculate, as features of the images, image features obtained by integrating local features extracted from the images and the object region information. Examples of the integration means 342X include the integration unit 342 in the first example embodiment.

The retrieval means 36X is configured to retrieve an image related to the input information from the image database, based on a degree of similarity between the image features and features of the input information. Examples of “feature of input information” include “retrieval input features” in the first example embodiment. Examples of the retrieval means 36X include the retrieval unit 36 according to the first example embodiment.

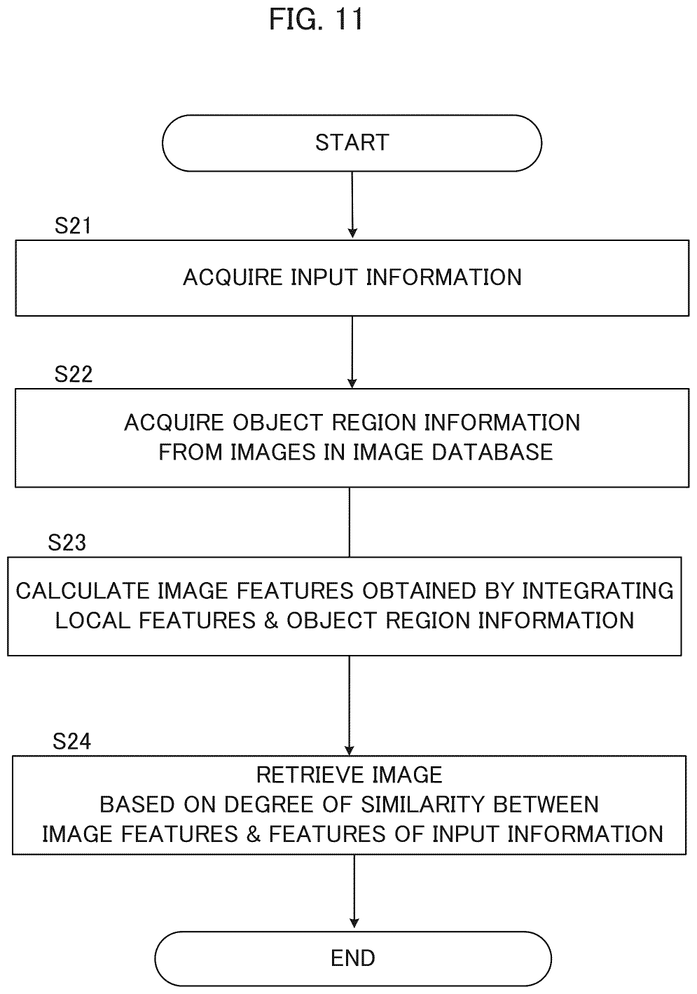

FIG. 11 is an exemplary flowchart illustrating the process of the image retrieval device 1X. First, the first acquisition means 30X acquires input information regarding a retrieval (step S21). Then, the second acquisition means 33X acquires object region information regarding a region of an object included in images in an image database where the retrieval is performed (step S22). Then, the integration means 342X calculates, as features of the images, image features obtained by integrating local features extracted from the images and the object region information (step S23). The retrieval means 36X retrieves an image related to the input information from the image database, based on a degree of similarity between the image features and features of the input information (step S24).

According to the second example embodiment, the image retrieval device 1X can accurately retrieve the image related to the input information regarding the retrieval from the image database.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

In addition, some or all of the above-described example embodiments (including modifications, the same shall apply hereinafter) may also be described as follows, but are not limited to the following. Furthermore, within the range defined by the above-described example embodiments, regardless of the device, method, and storage medium described in the following Supplementary Notes, some or all of the configurations described in the following Supplementary Notes may be applied to any hardware, software, system and recording means (including the storage medium) for recording a software.

### [Supplementary Note 1]

An image retrieval device comprising:
a first acquisition means configured to acquire input information regarding a retrieval;
a second acquisition means configured to acquire object region information regarding a region of an object included in images in an image database where the retrieval is performed;
an integration means configured to calculate, as features of the images, image features obtained by integrating the object region information and local features which are extracted from the images; and
a retrieval means configured to retrieve an image related to the input information from the image database, based on a degree of similarity between the image features and features of the input information.

### [Supplementary Note 2]

The image retrieval device according to Supplementary Note 1, wherein the integration means is configured to determine, based on the object region information, at least one of a key and/or a query used in integrating the local features based on an attention mechanism.

### [Supplementary Note 3]

The image retrieval device according to Supplementary Note 2,
wherein the integration means is configured to determine the query based on a position of the region indicated by the object region information.

### [Supplementary Note 4]

The image retrieval device according to Supplementary Note 3,
wherein the integration means is configured to determine, based on a position of a local region corresponding to the local features, the key corresponding to the local features.

### [Supplementary Note 5]

The image retrieval device according to any one of Supplementary Notes 2 to 4,
wherein the integration means is configured to adjust a magnitude of a component of the query projected onto a subspace of the key corresponding to the region which is indicated by the object region information.

### [Supplementary Note 6]

The image retrieval device according to any one of Supplementary Notes 1 to 5,
wherein the second acquisition means is configured to acquire the object region information regarding the region of the object selected based on the input information.

### [Supplementary Note 7]

The image retrieval device according to any one of Supplementary Notes 1 to 6,
wherein the second acquisition means is configured to acquire the object region information corresponding to the image from a database which stores the object region information.

### [Supplementary Note 8]

The image retrieval device according to Supplementary Note 7,
wherein the database stores the object region information associated with metadata regarding respective objects shown in the images, and
wherein the second acquisition means is configured to acquire the object region information associated which the metadata related to the input information.

### [Supplementary Note 9]

An image retrieval method executed by a computer, comprising:
acquiring input information regarding a retrieval;
acquiring object region information regarding a region of an object included in images in an image database where the retrieval is performed;
calculating, as features of the images, image features obtained by integrating the object region information and local features which are extracted from the images; and
retrieving an image related to the input information from the image database, based on a degree of similarity between the image features and features of the input information.

### [Supplementary Note 10]

A storage medium storing a program executed by a computer, the program causing the computer to:
acquire input information regarding a retrieval;
acquire object region information regarding a region of an object included in images in an image database where the retrieval is performed;
calculate, as features of the images, image features obtained by integrating the object region information and local features which are extracted from the images; and
retrieve an image related to the input information from the image database, based on a degree of similarity between the image features and features of the input information.

### [Supplementary Note 11]

The image retrieval device according to any one of Supplementary Notes 1 to 8,
wherein the input information includes text information, and
wherein the retrieval means is configured to retrieve, based on the degree of similarity between the image features and features of the text information, the image related to the input information.

### [Supplementary Note 12]

The image retrieval device according to any one of Supplementary Notes 1 to 8 and 11,
wherein the retrieval means is configured to
   generate, based on the image features of a display image which is displayed as a result of the retrieval, a caption of the display image and
   display, on a display device, the display image and the caption.

### [Supplementary Note 13]

The image retrieval device according to any one of Supplementary Notes 1 to 8, 11 and 12,
wherein the retrieval means is configured to
   divide the results of the retrieval into plural classes according to the size of the region of the object included in a positive example image corresponding to the input information,
calculate evaluation index values for the respective plural classes, and
integrate the calculated evaluation index values.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. Each example embodiment can be appropriately combined with other example embodiments. All Patent and Non-Patent Literatures mentioned in this specification are incorporated by reference in its entirety.

### DESCRIPTION OF REFERENCE NUMERALS

1, 1X Image retrieval device
2 Storage device
3 Display device
4 Input device
11 Processor
12 Memory
13 Interface
21 Image DB
22 Object region information DB
100 Image retrieval system

What is claimed is:

1. An image retrieval device comprising:
at least one memory configured to store instructions; and
at least one processor configured to execute the instructions to:
acquire input information regarding a retrieval;
acquire object region information regarding a region of an object included in images in an image database where the retrieval is performed;
calculate, as features of the images, image features obtained by integrating the object region information and local features which are extracted from the images; and
retrieve an image related to the input information from the image database, based on a degree of similarity between the image features and features of the input information.

2. The image retrieval device according to claim 1,
wherein the at least one processor is configured to determine, based on the object region information, at least one of a key and/or a query used in integrating the local features based on an attention mechanism.

3. The image retrieval device according to claim 2,
wherein the at least one processor is configured to determine the query based on a position of the region indicated by the object region information.

4. The image retrieval device according to claim 3,
wherein the at least one processor is configured to determine, based on a position of a local region corresponding to the local features, the key corresponding to the local features.

5. The image retrieval device according to claim 2,
wherein the at least one processor is configured to adjust a magnitude of a component of the query projected onto a subspace of the key corresponding to the region which is indicated by the object region information.

6. The image retrieval device according to claim 1,
wherein the at least one processor is configured to acquire the object region information regarding the region of the object selected based on the input information.

7. The image retrieval device according to claim 1,
wherein the at least one processor is configured to acquire the object region information corresponding to the image from a database which stores the object region information.

8. The image retrieval device according to claim 7,
wherein the database stores the object region information associated with metadata regarding respective objects shown in the images, and
wherein the at least one processor is configured to acquire the object region information associated which the metadata related to the input information.

9. An image retrieval method executed by a computer, comprising:
acquiring input information regarding a retrieval;
acquiring object region information regarding a region of an object included in images in an image database where the retrieval is performed;
calculating, as features of the images, image features obtained by integrating the object region information and local features which are extracted from the images; and
retrieving an image related to the input information from the image database, based on a degree of similarity between the image features and features of the input information.

10. A non-transitory computer readable storage medium storing a program executed by a computer, the program causing the computer to:
acquire input information regarding a retrieval;
acquire object region information regarding a region of an object included in images in an image database where the retrieval is performed;
calculate, as features of the images, image features obtained by integrating the object region information and local features which are extracted from the images; and
retrieve an image related to the input information from the image database, based on a degree of similarity between the image features and features of the input information.
